(19) United States
(12) Patent Application Publication
(10) Pub. No.: US 2022/0036526 A1
(43) Pub. Date: Feb. 3, 2022

(54) METHOD, SYSTEM, AND COMPUTER READABLE MEDIUM FOR REMOVING FLARE IN IMAGES

(71) Applicant: GUANGDONG OPPO MOBILE TELECOMMUNICATIONS CORP., LTD., Dongguan (CN)

(72) Inventor: Jun Luo, Yokohama (JP)

(73) Assignee: GUANGDONG OPPO MOBILE TELECOMMUNICATIONS CORP., LTD., Dongguan (CN)

(21) Appl. No.: 17/502,788

(22) Filed: Oct. 15, 2021

Related U.S. Application Data
(63) Continuation of application No. PCT/CN2019/083847, filed on Apr. 23, 2019.

(51) Int. Cl. G06T 5/50; H04N 5/235; G06T 7/00; G06T 5/00; H04N 5/243

(52) U.S. Cl. CPC G06T 5/50; H04N 5/2351; G06T 7/0002; G06T 2207/30168; H04N 5/243; G06T 2207/10144; G06T 5/002

(57) ABSTRACT

In an embodiment, a method for removing flare in images is proposed. The method includes utilizing an image capturing unit to continuously take an equally-exposed image and under-exposed images with variant exposure settings; determining whether a flare is in the equally-exposed image; in response to determining that the flare is in the equally-exposed image, aligning image objects of the under-exposed images with respect to the equally-exposed image; and removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised. Also, a system and a non-transitory computer-readable medium performing the method are provided.

### CROSS REFERENCE TO RELATED APPLICATIONS

This Application is a continuation of International Application No.: PCT/CN2019/083847, filed Apr. 23, 2019, the contents of which are incorporated herein by reference in their entirety.

### FIELD OF DISCLOSURE

The present disclosure relates to image processing technologies, and more particularly, to a method, system, and computer-readable medium for removing flare in images.

### BACKGROUND

With development of portable devices such as smartphones, tablets, and etc., the demands for a large screen ratio gradually increase. A true “all-display” is wanted by users for immersive viewing experience. In order to achieve the large screen ratio or carry out a device with a “full-screen” display, a front-facing camera-equipped terminal device hide its front-facing camera under the display. That is, the front-facing camera is located beneath the display. Light passing through the display is received by the front-facing camera in photographing or video recording. However, the light passing through the display will be affected by internal structures such as scan lines, data lines, and etc., which will cause a diffraction effect. Accordingly, the images taken using the camera located beneath the display will get flare from a bright light source. This greatly lowers image quality. Therefore, there is a need to solve the problems in the existing arts of this field.

### SUMMARY OF DISCLOSURE

An object of the present disclosure is to propose a method, system, and computer-readable medium for removing flare in images.

In a first aspect of the present disclosure, a method for removing flare in images is provided. The images are taken by an image capturing unit which is disposed under a display of an electronic device. The flare is caused by a diffraction effect generated when light passes through internal structures of the display. The method comprises:

utilizing the image capturing unit to continuously take an equally-exposed image and under-exposed images with variant exposure settings;

determining whether the flare is in the equally-exposed image;

in response to determining that the flare is in the equally-exposed image, aligning image objects of the under-exposed images with respect to the equally-exposed image; and

removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised.

According to an embodiment in conjunction with the first aspect of the present disclosure, the determining whether the flare is in the equally-exposed image comprises:

identifying alight source in the equally-exposed image by comparing the brightness of pixels of the equally-exposed image with a brightness threshold.

According to an embodiment in conjunction with the first aspect of the present disclosure, after the identifying the light source in the equally-exposed image, the determining whether the flare is in the equally-exposed image further comprises:

determining a region of interest (ROI) encapsulating the light source;

determining whether a pattern in an area surrounding the light source and within the ROI. conforms to a predetermined pattern; and

determining that the flare is in the equally-exposed image in response to determining that the pattern in the area conforms to the predetermined pattern and determining that the flare is not in the equally-exposed image in response to determining that the pattern in the area does not conform to the predetermined pattern.

According to an embodiment in conjunction with the first aspect of the present disclosure, the pattern is a pattern in color distribution.

According to an embodiment in conjunction with the first aspect of the present disclosure, the pattern is a spatial feature pattern.

According to an embodiment in conjunction with the first aspect of the present disclosure, the removing the flare in the equally-exposed image by using the aligned under-exposed images comprises:

dividing frequencies of each of the equally-exposed image and the under-exposed images in frequency domain into different frequency channels separately;

for each of the frequency channels, normalizing the brightness of each of the under-exposed images based on the brightness of the equally-exposed image;

denoising the normalized under-exposed images by overlapping the normalized under-exposed images in each of the frequency channels; and

replacing at least one of the frequency channels of the equally-exposed image to which the flare belongs with denoised signals corresponding to the at least one of the frequency channels of the denoised under-exposed images.

In a second aspect of the present disclosure, a system for removing flare in images is provided. The images are taken by an image capturing unit which is disposed under a display of an electronic device. The flare is caused by a diffraction effect generated when light passes through internal structures of the display. The system comprises:

at least one memory configured to store program instructions;

at least one processor configured to execute the program instructions, which cause the at least one processor to perform steps comprising:

utilizing the image capturing unit to continuously take an equally-exposed image and under-exposed images with variant exposure settings;

determining whether the flare is in the equally-exposed image;

in response to determining that the flare is in the equally-exposed image, aligning image objects of the under-exposed images with respect to the equally-exposed image; and

removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised.

According to an embodiment in conjunction with the second aspect of the present disclosure, the determining whether the flare is in the equally-exposed image comprises:

identifying a light source in the equally-exposed image by comparing the brightness of pixels of the equally-exposed image with a brightness threshold.

According to an embodiment in conjunction with the second aspect of e present disclosure, after the identifying the light source in the equally-exposed image, the determining whether the flare is in the equally-exposed image further comprises:

determining a region of interest (ROI) encapsulating the light source;

determining whether a pattern in an area surrounding the light source and within the ROI conforms to a predetermined pattern; and

determining that the flare is in the equally-exposed image in response to determining that the pattern in the area conforms to the predetermined pattern and determining that the flare is not in the equally-exposed image in response to determining that the pattern in the area does not conform to the predetermined pattern.

According to an embodiment in conjunction with the second aspect of e present disclosure, the pattern is a pattern in color distribution.

According to an embodiment in conjunction with the second aspect of the present disclosure, the pattern is a spatial feature pattern.

According to an embodiment in conjunction with the second aspect of the present disclosure, the removing the flare in the equally-exposed image by using the aligned under-exposed images comprises:

dividing frequencies of each of the equally-exposed image and the under-exposed images in frequency domain into different frequency channels separately;

for each of the frequency channels, normalizing the brightness of each of under-exposed images based on the brightness of the equally-exposed image;

denoising the normalized under-exposed images by overlapping the normalized under-exposed images in each of the frequency channels; and

replacing at least one of the frequency channels of the equally-exposed image to which the flare belongs with denoised signals corresponding to the at least one of the frequency channels of the denoised under-exposed images.

In a third aspect of the present disclosure, a non-transitory computer-readable medium utilized for removing flare in images is provided. The images are taken by an image capturing unit which is disposed under a display of an electronic device. The flare is caused by a diffraction effect generated when light passes through internal structures of the display. The non-transitory computer-readable medium is deployed with program instructions stored thereon, that when executed by at least one processor, cause the at least one processor to perform steps comprising:

utilizing the image capturing unit to continuously take an equally-exposed image and under-exposed images with variant exposure settings;

determining whether the flare is in the equally-exposed image;

in response to determining that the flare is in the equally-exposed image, aligning image objects of the under-exposed images with respect to the equally-exposed image; and

removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised.

According to an embodiment in conjunction with the third aspect of the present disclosure, the determining whether the flare is in the equally-exposed image comprises:

identifying a light source in the equally-exposed image by comparing the brightness of pixels of the equally-exposed image with a brightness threshold.

According to an embodiment in conjunction with the third aspect of the present disclosure, after the identifying the light source in the equally-exposed image, the determining whether the flare is in the equally-exposed image further comprises:

determining a region of interest (ROI) encapsulating the light source;

determining whether a pattern in an area surrounding the light source and within the ROI conforms to a predetermined pattern; and

determining that the flare is in the equally-exposed image in response to determining that the pattern in the area conforms to the predetermined pattern and determining that the flare is not in the equally-exposed image in response to determining that the pattern in the area does not conform to the predetermined pattern.

According to an embodiment in conjunction with the third aspect of the present disclosure, the pattern is a pattern in color distribution.

According to an embodiment in conjunction with the third aspect of the present disclosure, the pattern is a spatial feature pattern.

According to an embodiment in conjunction with the third aspect of the present disclosure, the removing the flare in the equally-exposed image by using the aligned under-exposed images comprises:

dividing frequencies of each of the equally-exposed image and the under-exposed images in frequency domain into different frequency channels separately;

for each of the frequency channels, normalizing the brightness of each of the under-exposed images based on the brightness of the equally-exposed image;

denoising the normalized under-exposed images by overlapping the normalized under-exposed images in each of the frequency channels; and

replacing at least one of the frequency channels of the equally-exposed image to which the flare belongs with denoised signals corresponding to the at least one of the frequency channels of the denoised under-exposed images.

In the present disclosure, the flare in images that is caused by a diffraction effect generated when light passes through the internal structures of the display is removed in using the image capturing unit disposed under the display to take the images, thereby improving the image quality.

### BRIEF DESCRIPTION OF DRAWINGS

In order to more clearly illustrate the embodiments of the present disclosure or related art, the following figures will be described in the embodiments are briefly introduced. It obvious that the drawings are merely some embodiments of the present disclosure, a person having ordinary skill in this field can obtain other figures according to these figures without paying the premise.

FIG. 1 is schematic diagram illustrating an electronic device with an image capturing unit disposed under a display according to an embodiment of the present disclosure.

FIG. 2 is a flowchart of a method for removing flare in images according to an embodiment of the present disclosure.

FIG. 3 is a flowchart of a flare removing step according to an embodiment of the present disclosure.

FIG. 4 is a block diagram illustrating an electronic device for implementing a method for removing flare in images according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

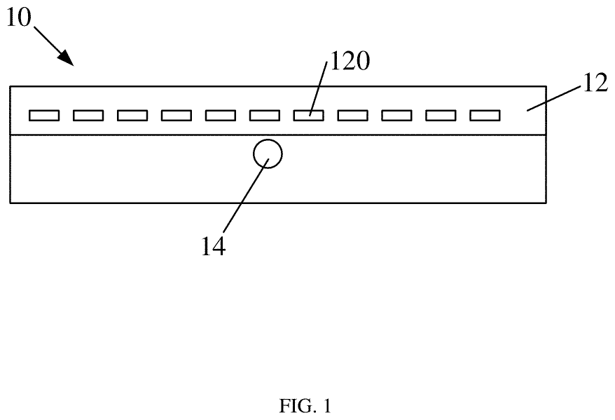

Referring to FIG. 1, an electronic device 10 with a display 12 and an image capturing unit (e.g., a camera) 14 disposed under or located beneath the display 12 is provided. The display 12 is transparent and allows light to pass through the display 12 to reach the image capturing unit 14. The display 12 includes internal structures 120 such as scan lines, data lines, and etc., that will affect transmission of the light from the display 12 to the image capturing unit 14. A diffraction effect is almost inevitably caused because of the internal structures 120 and reflected in images taken by the image capturing unit 14. The image taken using the image capturing unit 14 will get flare from a bright light source due to the diffraction effect, thereby lowering image quality.

The electronic device 10 can be realized by a mobile terminal such as a mobile phone, smartphone, personal digital assistants (PDA), tablet, and video gaming device, a portable terminal such as a laptop and notebook, or a relatively large-sized device such as a computer display and television, or any other type of device having the image capturing unit 14 unit hided below or inside the display 12.

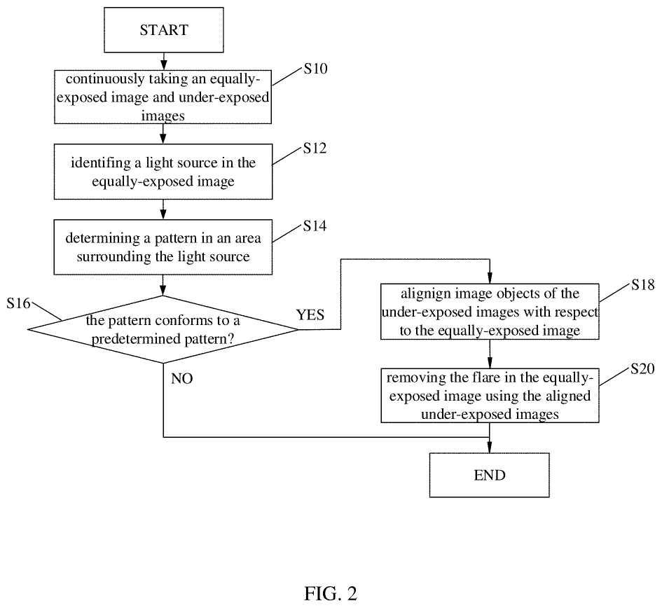

In order to eliminate the flare in taking an image of a scene including a bright light source, the present disclosure provides a method for removing flare in images, which is applicable at least to the scenario described in above context. Referring to FIG. 2, the method is described in more detail below.

In Step S10, the image capturing unit 14 is utilized to continuously take an equally-exposed image and under-exposed images with variant exposure settings. When the image capturing unit 14 is used to take an image of a scene, the image capturing unit 14 will generate an equally-exposed image and several under-exposed image for the same scene. The equally-exposed image may be with a default exposure settings for photographing a scene. The under-exposed images may be with exposure settings having exposure time less than that of the default exposure settings. That is, brightness of the under-exposed images is generally less than that of the equally-exposed image. The under-exposed images are used to compensate flare info of the equally-exposed image, which will be described in more detail below.

The process determines whether a flare is in the equally-exposed image. If there is a flare in the equally-exposed image, it means that there is a need to remove the flare and the process goes to Step 16. If no flare is in the equally-exposed image, there is no need to remove the flare and the process will be terminated in accompanying with outputting the equally-exposed image without any flare info compensation.

In Step S12, in order to determine whether the flare is in the equally-exposed image, it may have to identify a light source in the equally-exposed image. This may be done by comparing the brightness of pixels of the equally-exposed image with a brightness threshold. That is, if the number of the pixels of the equally-exposed image having brightness higher than the brightness threshold is large, it may be determined that there is a light source in the equally-exposed image. Conversely, if the number of the pixels of the equally-exposed image having brightness higher than the brightness threshold is small, it may be determined that there is no or barely no light source in the equally-exposed image. If such a light source is determined not in the equally-exposed image, it may be determined that there is no flare in the equally-exposed image and no need to execute the flare removing.

In Step S14, the process determines a flare pattern for comparing with a predetermined flare pattern (Step S16) to determine whether the flare is in the equally-exposed image. In this step, a region of interest (ROI) may be first determined. The ROI is a region encapsulating the light source. The ROI also includes a flare area (if exists) located around the light source. That is, the ROI may include an area where the light source occupies and an area surrounding the light source. Once the area surrounding the light source and within the ROI is determined, the process determines a pattern in the area surrounding the light source. The pattern will reflect characteristics of the flare if the flare is in the equally-exposed image and accordingly, can be used to determine whether the flare is in the equally-exposed image.

In Step S16, the process is to determine whether a pattern in the area surrounding the light source (i.e., the flare may be located at such an area) conforms to a predetermined pattern. If the pattern in such an area conforms to the predetermined pattern, it may be determined that the flare is detected. Conversely, if the pattern in such an area does not conforms to the predetermined pattern, it may be determined that there is no flare in the equally-exposed image. If the process determines that there is a flare in the equally-exposed image, the flare removing is to be executed and the process goes to Step S18. If the process determines that there is no flare in the equally-exposed image, the process will be terminated in accompanying with outputting the equally-exposed image without any flare info compensation.

In an embodiment, the aforesaid pattern is a pattern in color distribution. That is, the color distribution of the area surrounding the light source may be compared to a predetermined flare color distribution. If the two conforms to each other, it may be determined that the flare is in the equally-exposed image. The color distribution comparison may be executed in separate colors, for example, red, green, and blue channels. The color distribution comparison is performed for each of the color channels.

In an embodiment, the aforesaid pattern is a spatial feature pattern. The flare has an irradiated stripe pattern. It may check a spatial pattern in the area surrounding the light source to determine whether the spatial pattern in such an area conforms to the irradiated stripe pattern. Edge detection may be utilized in this pattern searching. If the spatial pattern in the area surrounding the light source conforms to the irradiated stripe pattern (i.e., the predetermined pattern), it can be determined that the flare is in the equally-exposed image.

In Step S18, in order to remove the flare in the equally-exposed image, it may firstly have to align image objects of the under-exposed images with respect to the equally-exposed image. Since the equally-exposed image and the under-exposed images are taken at different time points, image objects may shift in their positions for the equally-exposed image and the under-exposed images. Accordingly, it may have to align the image objects of the under-exposed images with respect to the equally-exposed image such that the position of the image objects of the under-exposed images may correspond to that of the equally-exposed image. This can be done by utilizing traditional image aligning approaches.

In Step S20, the aligned under-exposed images are then used to remove the flare in the equally-exposed image. In this step, the flare info of the equally-exposed image is compensated using the aligned under-exposed images. Since there is no or barely no flare in the under-exposed images in comparison to the equally-exposed image, the under-exposed images can be used to remove the flare in the equally-exposed image. The aligned under-exposed images may be further processed in order to get a better result in the flare removing. In an embodiment, the aligned under-exposed images are normalized in brightness based on the brightness of the equally-exposed image and the normalized under-exposed images are then denoised. For example, the brightness of the aligned under-exposed images is adjusted to be consistent with the brightness of the equally-exposed image. That is, this increases the brightness of the aligned under-exposed images. Increasing the brightness of the aligned under-exposed images may generate noises and accordingly, there is a need to denoise the under-exposed images with normalized brightness. The denoising may be done using traditional denoising approaches. The denoising may include spatial filtering which may using a spatial filter and/or temporal filtering which may be achieved by overlapping the under-exposed images. The denoising may also be achieved by overlapping the under-exposed images (corresponding to the temporal filtering) and then applying a spatial filter (corresponding to the spatial filtering) to the overlapped version of the under-exposed images.

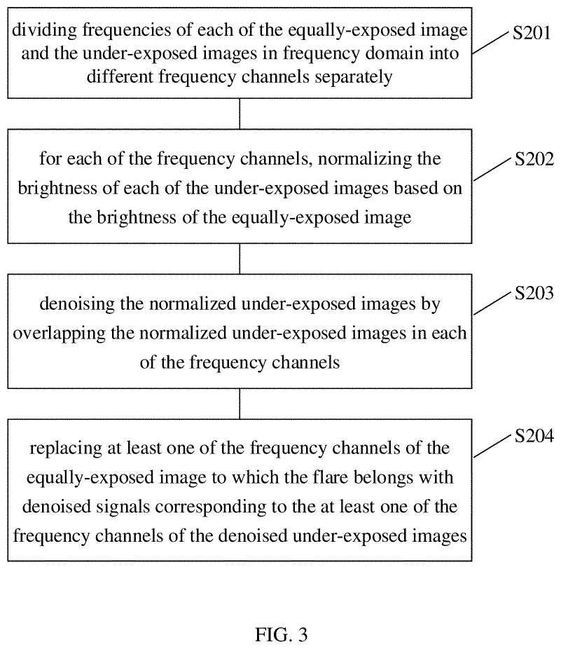

Referring to FIG. 3, the flare removing step (i.e., Step S20) may include the following steps. Frequencies of each of the equally-exposed image and the aligned under-exposed images in frequency domain are divided into different frequency channels separately (Step S201). For example, a high frequency channel, a middle frequency channel, and a low frequency channel are specified in the frequency dividing step. That is, each of the equally-exposed image and the aligned under-exposed images are divided into the high frequency channel, the middle frequency channel, and the low frequency channel in the frequency domain. For each of the frequency channels, the brightness of each of the under-exposed images is normalized based on the brightness of the equally-exposed image (Step S202). For example, for each of the high frequency channel, the middle frequency channel, and the low frequency channel, the brightness of each of the under-exposed images is adjusted to be consistent with the brightness of the equally-exposed image. That is, the brightness of each of the under-exposed images in the high frequency channel is adjusted to be consistent with the brightness of the equally-exposed image in the high frequency channel, and similar or the same process is executed for the middle frequency channel and the low frequency channel. After that, the normalized under-exposed images are denoised by overlapping the normalized under-exposed images (corresponding to the temporal filtering as described above) in each of the frequency channels (Step S203). That is, the normalized under-exposed images in the high frequency channel are overlapped with each other, the normalized under-exposed images in the middle frequency channel are overlapped, and the normalized under-exposed images in the low frequency channel are overlapped. Also, a spatial filter (corresponding to the spatial filtering as described above) may be further applied to the overlapped version of the under-exposed images to get a better result in image denoising. After that, at least one of the frequency channels of the equally-exposed image to which the flare belongs is replaced with denoised signals corresponding to the at least one of the frequency channels of the denoised under-exposed images (Step S204). For example, the flare and the light source usually reside correspondingly in the high frequency channel or in the high and middle frequency channels. The high frequency channel (or the high and middle frequency channels) of the equally-exposed image may be replaced with the denoised signals corresponding to the high frequency channel (or the high and middle frequency channels) of the denoised under-exposed images to remove the flare in the equally-exposed image.

In the present disclosure, the flare in images that is caused by a diffraction effect generated when light passes through the internal structures of the display is removed in using the image capturing unit disposed under the display to take the images, thereby improving the image quality.

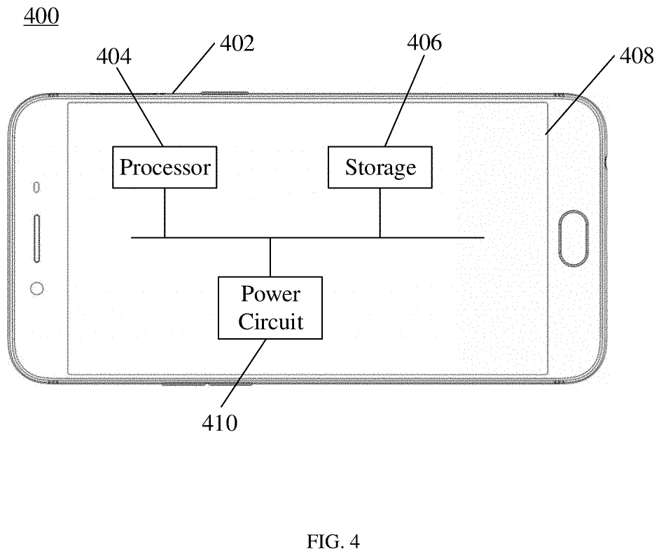

FIG. 4 is a block diagram illustrating an electronic device 400 according to an embodiment of the present disclosure. For example, the electronic device 400 can be a mobile phone, a game controller, a tablet device, a medical equipment, an exercise equipment, or a personal digital assistant (PDA).

Referring to FIG. 4, the electronic device 400 may include one or a plurality of the following components: a housing 402, a processor 404, a storage 406, a circuit board 408, and a power circuit 410. The circuit board 408 is disposed inside a space defined by the housing 402. The processor 404 and the storage 406 are disposed on the circuit board 408. The power circuit 410 is configured to supply power to each circuit or device of the electronic device 400. The storage 406 is configured to store executable program codes. By reading the executable program codes stored in the storage 406, the processor 404 runs a program corresponding to the executable program codes to execute the flare removing method of any one of the afore-mentioned embodiments.

The processor 404 typically controls overall operations of the electronic device 400, such as the operations associated with display, telephone calls, data communications, camera operations, and recording operations. The processor 404 may include one or more processor 404 to execute instructions to perform actions at all or part of the steps in the above described methods. Moreover, the processor 404 may include one or more modules which facilitate the interaction between the processor 404 and other components. For instance, the processor 404 may include a multimedia module to facilitate the interaction between the multimedia component and the processor 404.

The storage 406 is configured to store various types of data to support the operation of the electronic device 400. Examples of such data include instructions for any application or method operated on the electronic device 400, contact data, Phonebook data, messages, pictures, video, etc. The storage 406 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power circuit 410 supplies power to various components of the electronic device 400. The power circuit 410 may include a power management system, one or more power sources, and any other component associated with generation, management, and distribution of power for the electronic device 400.

In exemplary embodiments, the electronic device 400 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the storage 406, executable by the processor 404 of the electronic device 400 for performing the above-described methods. For example, the non-transitory computer-readable storage medium may be a ROM, a random access memory (RAM), a CD-ROM, a magnetic tape, a floppy disc, an optical data storage device, and the like.

A person having ordinary skill in the art understands that each of the units, modules, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and module in the above-mentioned embodiment since the working processes of the above-mentioned system, device, and module are basically the same. For easy description and simplicity, these working processes will not be detailed.

It is understood that the disclosed system, device, and method in the embodiments of the present disclosure can be realized with other ways. The above-mentioned embodiments are exemplary only. The division of the modules is merely based on logical functions while other divisions exist in realization. It is possible that a plurality of modules or components are combined or integrated in another system. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules for display are or are not physical modules, that is, located in one place or distributed on a plurality of network modules. Some or all of the modules are used according to the purposes of the embodiments.

Moreover, each of the functional modules in each of the embodiments can be integrated in one processing module, physically independent, or integrated in one processing module with two or more than two modules.

If the software function module is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for removing flare in images, the images taken by an image capturing unit which is disposed under a display of an electronic device, the flare caused by a diffraction effect generated when light passes through internal structures of the display, the method comprising:
utilizing the image capturing unit to continuously take an equally-exposed image and under-exposed images with variant exposure settings;
determining whether the flare is in the equally-exposed image;
in response to determining that the flare is in the equally-exposed image, aligning image objects of the under-exposed images with respect to the equally-exposed image; and
removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised.

2. The method according to claim 1, wherein the determining whether the flare is in the equally-exposed image comprises:
identifying a light source in the equally-exposed image by comparing the brightness of pixels of the equally-exposed image with a brightness threshold.

3. The method according to claim 2, wherein after the identifying the light source the equally-exposed image, the determining whether the flare is in the equally-exposed image further comprises:
determining a region of interest (ROI) encapsulating the light source;
determining whether a pattern in an area surrounding the light source and within the ROI conforms to a predetermined pattern; and
determining that the flare is in the equally-exposed image in response to determining that the pattern in the area conforms to the predetermined pattern and determining that the flare is not in the equally-exposed image in response to determining that the pattern in the area does not conform to the predetermined pattern.

4. The method according to claim 3, wherein the pattern is a pattern in color distribution.

5. The method according to claim 3, wherein the pattern is a spatial feature pattern.

6. The method according to claim 1, wherein the removing the flare in the equally-exposed image by using the aligned under-exposed images comprises:
dividing frequencies of each of the equally-exposed image and the under-exposed images in frequency domain into different frequency channels separately;
for each of the frequency channels, normalizing the brightness of each of the under-exposed images based on the brightness of the equally-exposed image;
denoising the normalized under-exposed images by overlapping the normalized under-exposed images in each of the frequency channels; and
replacing at least one of the frequency channels of the equally-exposed image to which the flare belongs with denoised signals corresponding to the at least one of the frequency channels of the denoised under-exposed images.

7. A system for removing flare in images, the images taken by an image capturing unit which is disposed under a display of an electronic device, the flare caused by a diffraction effect generated when light passes through internal structures of the display, the system comprising:
at least one memory configured to store program instructions;
at least one processor configured to execute the program instructions, which cause the at least one processor to perform steps comprising:
utilizing the image capturing unit to continuously take an equally-exposed image and under-exposed images with variant exposure settings;
determining whether the flare is in the equally-exposed image;
in response to determining that the flare is in the equally-exposed image, aligning image objects of the under-exposed images with respect to the equally-exposed image; and. removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised.

8. The system according to claim 7, wherein the determining whether the flare is in th equally-exposed image comprises:
identifying a light source in the equally-exposed image by comparing the brightness of pixels of the equally-exposed image with a brightness threshold.

9. The system according to claim 8, wherein after the identifying the light source in the equally-exposed image, the determining whether the flare is in the equally-exposed image further comprises:
determining a region of interest (ROI) encapsulating the light source;
determining whether a pattern in an area surrounding the light source and within e conforms to a predetermined pattern; and
determining that the flare is in the equally-exposed image in response to determining that the pattern in the area conforms to the predetermined pattern and determining that the flare is not in the equally-exposed image in response to determining that the pattern in the area does not conform to the predetermined pattern.

10. The system according to claim 9, wherein the pattern is a pattern in color distribution.

11. The system according to claim 9, wherein the pattern is a spatial feature pattern.

12. The system according to claim 7, wherein the removing the flare in the equally-exposed image by using the aligned under-exposed images comprises:
dividing frequencies of each of the equally-exposed image and the under-exposed images in frequency domain into different frequency channels separately;
for each of the frequency channels, normalizing the brightness of each of e under-exposed images based on the brightness of the equally-exposed image;
denoising the normalized under-exposed images by overlapping the normalized under-exposed images in each of the frequency channels; and
replacing at least one of the frequency channels of the equally-exposed image to which the flare belongs with denoised signals corresponding to the at least one of the frequency channels of the denoised under-exposed images.

13. A non-transitory computer-readable medium, utilized for removing flare in images, the images taken by an image capturing unit which is disposed under a display of an electronic device, the flare caused by a diffraction effect generated when light passes through internal structures of the display, the non-transitory computer-readable medium deployed with program ructions stored thereon, that when executed by at least one processor, cause the at least one processor to perform steps comprising:
utilizing the image capturing unit to continuously take an equally-exposed image and under-exposed images with variant exposure settings;
determining whether the flare is in the equally-exposed image;
in response to determining that the flare is in the equally-exposed age, aligning image objects of the under-exposed images with respect to the equally-exposed image; and
removing the flare in the equally-exposed image by using the aligned under-exposed images, wherein the under-exposed images used to remove the flare in the equally-exposed image are normalized in brightness based on the brightness of the equally-exposed image and the normalized under-exposed images are then denoised.

14. The non-transitory computer-readable medium according to claim 13, wherein the determining whether the flare is in the equally-exposed image comprises:
identifying a light source in the equally-exposed image by comparing the brightness of pixels of the equally-exposed image with a brightness threshold.

15. The non-transitory computer-readable medium according to claim 14, wherein after the identifying the light source in the equally-exposed image, the determining whether the flare is in the equally-exposed image further comprises:
determining a region of interest (ROI) encapsulating the light source;
determining whether a pattern in an area surrounding the light source and within the ROT conforms to a predetermined pattern; and
determining that the flare is in the equally-exposed image in response to determining that the pattern in the area conforms to the predetermined pattern and determining that the flare is not in the equally-exposed image in response to determining that the pattern in the area does not conform to the predetermined pattern.

16. The non-transitory computer-readable medium according to claim 15, wherein the pattern is a pattern in color distribution.

17. The non-transitory computer-readable medium according to claim 15, wherein the pattern is a spatial feature pattern.

18. The non-transitory computer-readable medium according to claim 13, wherein the removing the flare in the equally-exposed image by using the aligned under-exposed images comprises:
dividing frequencies of each of the equally-exposed image and the under-exposed images in frequency domain into different frequency channels separately;
for each of the frequency channels, normalizing the brightness of each of the under-exposed images based on the brightness of the equally-exposed image;
denoising the normalized under-exposed images by overlapping the normalized under-exposed images in each of the frequency channels; and
replacing at least one of the frequency channels of the equally-exposed image to which the flare belongs with denoised signals corresponding to the at least one of the frequency channels of the denoised under-exposed images.
